(19) United States
(12) Patent Application Publication
(10) Pub. No.: US 2019/0139373 A1
(43) Pub. Date: May 9, 2019

(54) SYSTEMS AND METHODS FOR ENHANCING GAMING AWARDS VIA GAMBLING TICKETS SPANNING MULTIPLE EVENTS

(71) Applicant: KING SHOW GAMES, INC., Minnetonka, MN (US)

(72) Inventor: Jacob LAMB, Maple Grove, MN (US)

(21) Appl. No.: 16/183,875

(22) Filed: Nov. 8, 2018

Related U.S. Application Data
(60) Provisional application No. 62/583,415, filed on Nov. 8, 2017.

(51) Int. Cl. G07F 17/34; G07F 17/32

(52) U.S. Cl. CPC G07F 17/34; G07F 17/3244; G07F 17/3213

(57) ABSTRACT

Systems, apparatuses and methods for enhancing awards and/or providing additional awards in connection with gaming activities. A game play ticket may be configured to have multiple ticket symbols hidden to the player, and to have a winning combination of the ticket symbols among those ticket symbols. The game play ticket is presented with a gaming event, such as a slot game reel spin, where at least one of the ticket symbols is exposed. If a qualifying quantity of like ticket symbols have been exposed, a game play ticket award is provided, otherwise the game play ticket may be presented with other ones of the gaming events.

### FIELD

This disclosure relates generally to games, and more particularly to systems, apparatuses and methods for using gambling tickets to randomly provide and/or enhance gaming payouts.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is due to the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes systems, apparatuses and methods that facilitate new and interesting gaming experiences, and provide advantages over the prior art.

### SUMMARY

The present disclosure is directed to systems, apparatuses, computer-readable media, and/or methods that are configured to utilize scratch-off cards, pull tabs, and/or other gambling tickets to provide awards or to enhance awards in gaming activities.

In accordance with one embodiment, a slot game apparatus is provided for enhancing gaming awards in a slot game. The slot game apparatus includes at least a display, a user interface, a wager input device, and a processor. The display is configured to present symbols in symbol locations forming a symbol array, and to present a gaming ticket(s). The user interface includes at least one user input to enable a player to initiate and participate in successive slot game events presented via the symbol array. The wager input device is structured to identify and validate player assets, and to permit the player to play the slot game events when the player assets are provided. The processor is configured or otherwise programmed to configure a gaming ticket to have multiple ticket symbols hidden to the player, and to include at least one winning combination of the ticket symbols among the various ticket symbols. The processor is configured to expose one of the ticket symbols in connection with one of the slot game events, and to determine whether a qualifying number of like ones of the ticket symbols have been exposed over a plurality of the slot game events. If the winning combination of the ticket symbols occurs as a result of a qualifying number of like ones of the ticket symbols being exposed, the processor is configured to confer a gaming ticket award established for the winning combination of the ticket symbols; otherwise, the processor is configured to cause the display to present the gaming ticket in association with another one of the slot game events.

In a more particular embodiment of such a slot game apparatus, the slot game events refer to a slot game reel spin. In one embodiment, the processor is configured to cause the display to present the game play ticket for each slot game reel spin, where in other embodiments the processor is configured to cause the display to present the game play ticket on random slot game reel spins, and in still other embodiments the processor is configured to cause the display to present the game play ticket as a result of an occurrence in the symbol array of the slot game event.

In another particular embodiment of such a slot game apparatus, the processor repeats the exposing of ticket symbols, and determining whether a qualifying number of like ticket symbols have been exposed over some number of the slot game events, until the qualifying number of like ones of the ticket symbols have been exposed. In other embodiments, the processor is configured to configure a new gaming ticket in response to the qualifying number of like ones of the ticket symbols having been exposed.

In one embodiment of such a slot game apparatus, the processor is configured to cause the display to present the gaming ticket in association with the next consecutive slot game event if the winning combination of the ticket symbols does not occur. In another embodiment, the processor is configured to cause the display to present the gaming ticket in association with a future, nonconsecutive slot game event if the winning combination of the ticket symbols does not occur. In still another embodiment, the processor is configured to expose a randomly-selected ticket symbol in connection with one of the slot game events, where in other embodiments the processor is configured to expose a player-selected ticket symbol in connection with one of the slot game events. In still other embodiments, the processor may expose multiple ticket symbols in connection with one of the slot game events.

In accordance with another embodiment, a gaming apparatus utilizing symbols to identify winning results is provided. The gaming apparatus includes a symbol selection module configured to select symbols for a slot game event. The gaming apparatus includes a display to present the selected symbols in a symbol array of the slot game event, and to display a state of a multi-symbol gaming ticket. A ticket configuration module is configured to populate the multi-symbol gaming ticket with ticket symbols originally hidden from player perception. A ticket item selection module is coupled to the ticket configuration module and configured to select and reveal one (or more) of the ticket symbols. A ticket analysis module is coupled to the ticket item selection module to identify whether a qualifying number of like symbols have been revealed on the multi-symbol gaming ticket over the course of a plurality of the slot game events. An award enhancement module is configured to grant a ticket-based award in response to the qualifying number of like symbols having been revealed on the multi-symbol gaming ticket over the course of the plurality of the slot game events.

In accordance with one embodiment of such a gaming apparatus, the ticket item selection module is configured to select and reveal one of the ticket symbols each time a new one of the slot game events occurs, until the multi-symbol gaming ticket has expired.

In another embodiment of such a gaming apparatus, a slot symbol selection module is provided to select the symbols for the slot game event, where the award enhancement module is configured to provide the ticket-based award in the form of a guaranteed gaming result to the slot symbol selection module to cause the symbol selection module to force the guaranteed gaming result to occur via the symbol array of the slot game event.

In still another embodiment of such a gaming apparatus, a slot symbol selection module is provided to select the symbols for the slot game event, where the award enhancement module provides information to the slot symbol selection module to change the symbols on a subsequent slot game event(s) to increase the chance of winning via the slot game event. In a similar embodiment, such a slot symbol selection module may alternatively, or additionally, be configured to select the symbols for the slot game event, where the award enhancement module provides information to the slot symbol selection module to change the symbols on a subsequent slot game event to increase the chance of winning a larger payout via the slot game event.

In yet another embodiment of such a gaming apparatus, a primary award identification module is further provided, and coupled to the slot symbol selection module to identify winning gaming payouts resulting from the slot game event, and further coupled to the award enhancement module to receive the ticket-based award in the form of a payout modifier, where the primary award identification module is further configured to increase the winning gaming payouts by the payout modifier.

In another embodiment, a method is provided for enabling awards to be provided to players participating in gaming activities. Such a method may include configuring a game play ticket to have multiple ticket symbols hidden to the player, and at least one winning combination of the ticket symbols among the ticket symbols. The game play ticket is presented in association with a gaming event of the gaming activity, and one of the ticket symbols is exposed. It is determined whether a qualifying number of like ones of the ticket symbols have been exposed, and if so, a game play ticket award is provided. If it is determined that no winning combination of the ticket symbols occurred, the game play ticket may be presented in association with another one of the gaming events.

In one particular embodiment of such a method, the gaming activity involves a slot game, and the gaming event involves a randomization of slot game symbols on a slot game grid for win analysis. In one embodiment, such randomization of the slot game symbols involves a slot reel spin. Presenting the game play ticket may involve presenting the game play ticket for each reel spin (or other randomization of the slot game symbols), or may involve presenting the game play ticket on random reel spins (or other randomization of the slot game symbols), or may involve presenting the game play ticket as a result of an occurrence in the slot game (e.g., sub-symbol, random indication, symbol combination, etc.).

In another embodiment of such a method, the process may repeat for a particular game play ticket until the qualifying number of like ones of the ticket symbols have been exposed. In one embodiment, a new game play ticket may be assigned upon occurrence of a winning ticket symbol combination, or upon expiration of the game play ticket without a winning ticket symbol combination, etc.

In some embodiments, the game play tickets may be presented at any time, including before a reel spin (or other gaming event), during the reel spin, in some cases after the reel spin, etc.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a representative gaming machine capable of facilitating player use and interaction with games and features in accordance with the invention and representative embodiments described herein.

FIG. 2 is a block diagram illustrating a representative computing arrangement capable of implementing games and features in accordance with the invention and representative embodiments described herein.

FIGS. 3A and 3B are block diagrams of representative electronic or “virtual” scratch cards, pull tabs, and/or other multi-item elements are used to identify awards, award modifiers, etc.

FIG. 3C depicts an example where virtual scratch cards are used to identify a guaranteed slot game result.

FIG. 4 is a flow diagram depicting an embodiment of an interevent progression towards the awarding of a gaming asset to a gaming participant.

FIG. 5 illustrates a representative embodiment of an operational arrangement of a gaming device that beneficially provides gaming participants with manners of envisaging approaching opportunities to enhance gaming payouts.

FIG. 6 depicts a representative embodiment for forcing gaming results.

FIGS. 7A-7C depict representative examples of ticket configurations for qualifying numbers of matching symbols.

FIG. 8 is a block diagram of a representative gaming apparatus for enhancing payouts by tracking gaming occurrences in gaming activities.

FIGS. 9A and 9B are representative poker embodiment utilizing multi-item elements to identify primary or secondary awards.

### DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatuses.

In various embodiments, the gaming displays are described in conjunction with the use of data in the form of “symbols.” In the context of this disclosure, a “symbol” may generally refer at least to a collection of one or more arbitrary indicia or signs that have some conventional or defined significance. In particular, the symbol may represent values that can at least be used to determine whether to award a payout. A symbol may include numbers, letters, shapes, pictures, textures, colors, sounds, etc., and any combination therebetween. A play state, such as a win, can be determined by comparing the symbol with one or more other symbols. Such comparisons can be performed, for example, via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for providing awards in gaming activities, and more particularly for enhancing gaming payouts and/or providing payout modifiers and other payout enhancements via physical or electronic/virtual gambling tickets. Awards, award modifiers/enhancers, enriched symbols or symbol sets, and/or other player benefits having gaming-related value are available to the gaming participant, where at least some of such player benefits may occur in parallel with, or otherwise as an auxiliary gaming event to, other gaming activity (e.g., primary or main game results).

The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that involves enhancing gaming payouts and/or providing payout modifiers and other payout enhancements via physical or electronic/virtual gambling tickets or other information carriers. For example, multipliers, bonus triggers, progressive jackpots, guaranteed wins, wild symbol placements, and/or other gaming award-related features may be provided by pull tabs or scratch-off cards to identify the awarded prize.

Numerous variations are possible in view of these and other embodiments of the inventive concept. Representative embodiments and variations are described herein, with some embodiments described with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, roulette, bingo, keno, or other games of chance. Some of these other types of embodiments will be discussed below as variations to the examples illustrated. However, many other types of games can implement similar techniques and fall within the scope of this disclosed concept.

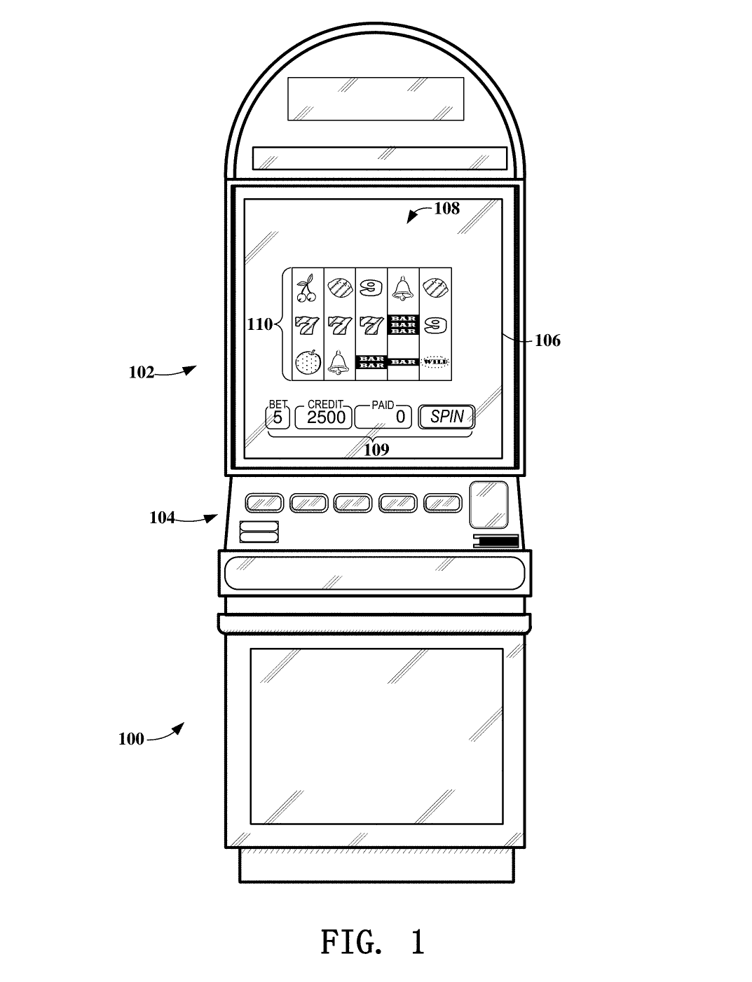

Referring to the example gaming apparatus 100 shown in FIG. 1, the representative gaming apparatus includes at least a display area(s) 102 (also referred to as a gaming display), and a player interface area(s) 104, although some or all of the interactive mechanisms included in the user interface area 104 may be provided via other or additional means, such as graphical icons used with a touch screen in the display area 102 in some embodiments. The display area 102 may include one or more game displays 106 (also referred to as “displays” or “gaming displays”) that may be included in physically separate displays or as portions of a common large display. Here, the representative game display 106 includes at least a primary game play portion 108 that displays game elements and symbols 110, and an operations portion 109 that can include meters, various game buttons and other input mechanisms, and/or other game information for a player of the gaming device 100.

The user interface 104 allows the user to control, engage in play of, and otherwise interact with the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, touchscreen input, tactile input, and/or any other user input system or mechanism that allows the user to play and interact with the particular gaming activity.

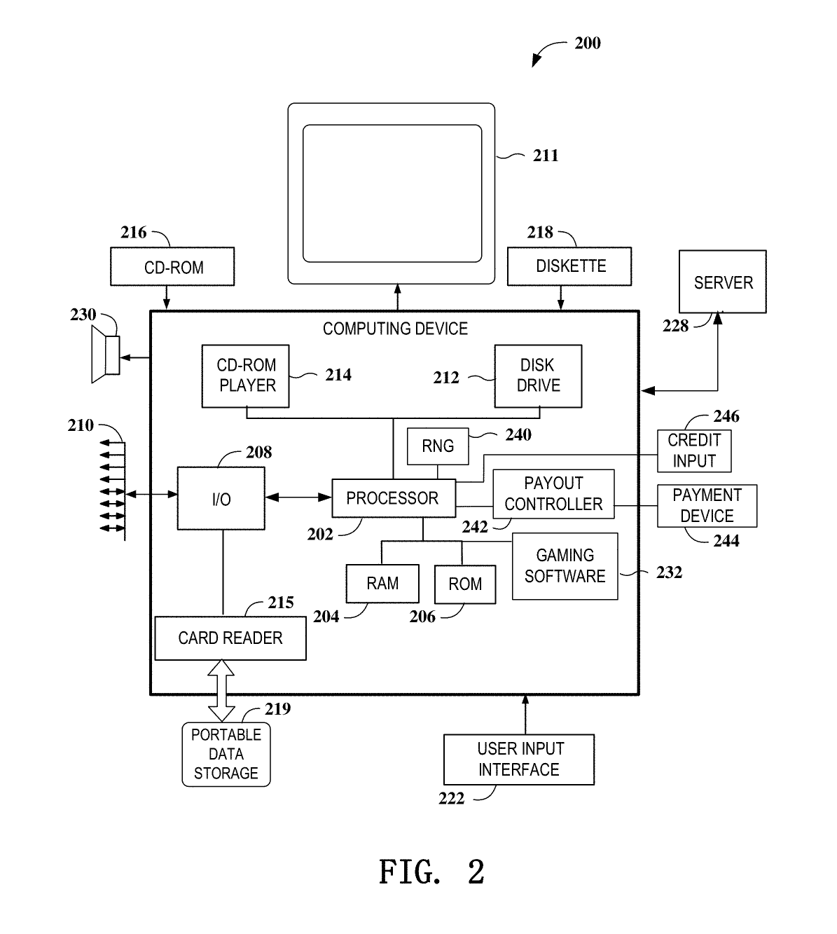

The user interface 104 may allow the user or player to enter coins, bills, or otherwise obtain credits through vouchers, tokens, credit cards, tickets, electronic money, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player information, such as player loyalty information to identify a user or player of the gaming device. This mechanism may be, for example, a card reader, biometric scanner, keypad, or other input device. It is through a user interface such as the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as pay table information associated with a glass/plastic panel(s) on the gaming machine 100 and/or graphical images. The symbols or other indicia associated with the play of the game may be presented on an electronic display device or on mechanical devices associated with a mechanical display. Generally, in some embodiments, the display 106 devotes the largest portion of viewable area to the primary gaming portion 108. The primary gaming portion 108 may provide visual feedback to the user for any selected game. The primary gaming portion 108 may render graphical objects such as cards, slot reels, dice, animated characters, and any other gaming visual known in the art. The primary gaming portion 108 may also inform players of the outcome of any particular event, including whether the event resulted in a win or loss.

In some example embodiments illustrated herein, the primary gaming portion 108 may display a grid (or equivalent arrangement) of game elements 110 or game element positions (also referred to herein as “reel stop positions”). As illustrated in the embodiment shown in FIG. 1, the grid includes three rows and five columns of game elements 110, which may form a game outcome(s) of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as pay tables, navigation controls, etc.

Although FIG. 1 illustrates a particular implementation of some of the embodiments of this invention in a casino or electronic gaming machine (“EGM”), one or more devices may be programmed to play various embodiments of the invention. The concepts and embodiments described herein may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the principles described herein is illustrated in FIG. 2.

Hardware, firmware, software or any combination thereof may be used to perform the various gaming functions, display presentations and operations described herein. The functional modules used in connection with the disclosure may reside in a gaming machine as described, or may alternatively reside on a stand-alone or networked computer. The representative computing structure 200 of FIG. 2 is an example of a computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions described herein includes a processor, such as depicted by the representative central processing unit (CPU) 202, coupled to memory, such as random access memory (RAM) 204, and some variation of read-only memory (ROM) 206 or other persistent storage. The ROM 206 may also represent other types of storage media to store programs, such as programmable ROM (PROM), erasable PROM (EPROM or any technology capable of storing data). The processor 202 may communicate with other internal and external components through input/output (I/O) circuitry 208 and bussing 210, to communicate control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to one or more displays 211, which represent a manner in which the gaming activities may be presented. The display 211 represents the “presentation” of the game information in accordance with the disclosure, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, inputting data to identify a player for a player loyalty system, etc. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG) or other random generator. The fixed and dynamic symbols generated as part of a gaming activity may be produced using one or more RNGs. RNGs may be implemented using hardware, software operable in connection with the processor 202, or some combination of hardware and software. The principles described herein are operable using any known RNG, and may be integrally programmed as part of the processor 202 operation, or alternatively may be a separate RNG controller 240 that may be associated with the computing arrangement 200 or otherwise accessible such as via a network. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server(s) 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 or other processor(s) indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 may also be provided in gaming machine embodiments, where the payment device 244 serves as the mechanism providing the payout to the player or participant. In some embodiments, the payment device 244 may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency or asset. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, or any other player assets, for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payment device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described herein. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a pay table. The software 232 may include instructions to provide other functionality as known in the art or as described and shown herein.

The systems, apparatuses and methods operable via these and analogous computing and gaming devices can support gaming features as described herein. In one embodiment, scratch-off cards, multiple-item pull tabs, or other instant lottery items are used as a means to provide gaming awards or award enhancements during game play.

Many embodiments may be described in terms of a slot game, where symbols may be matched on paylines to determine payout awards. However, the principles described herein are equally applicable to other games of chance, as described herein and as will be readily apparent to those skilled in the art from the teachings herein.

Electronic or physical scratch-off cards, multi-item pull tabs or selection boards, and/or other multi-item objects may be used to present an actual and/or perceived progression towards a state where an award, award modifier, increase in symbol participation value, increase in outcome value, increase in odds of winning, or the like, is provided. In such case, the scratch-off or other originally hidden area would reveal one of the awards, or an update to a count to get an award when the count reaches a predetermined or dynamically-determined value.

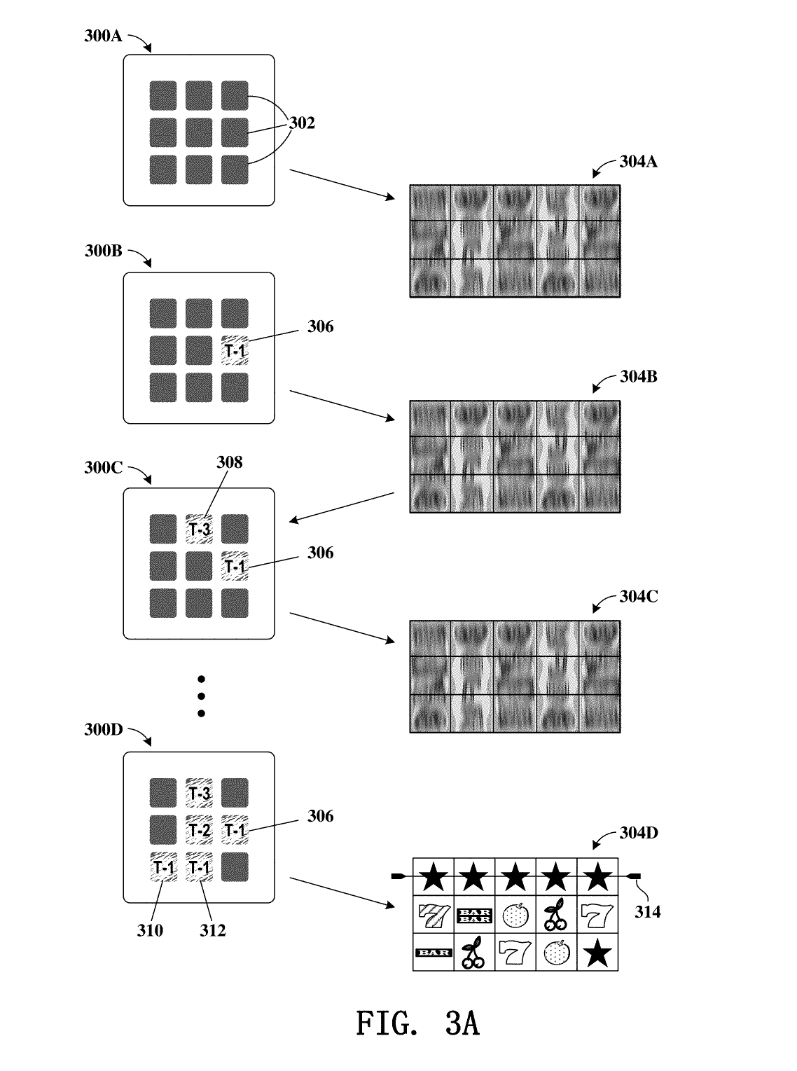

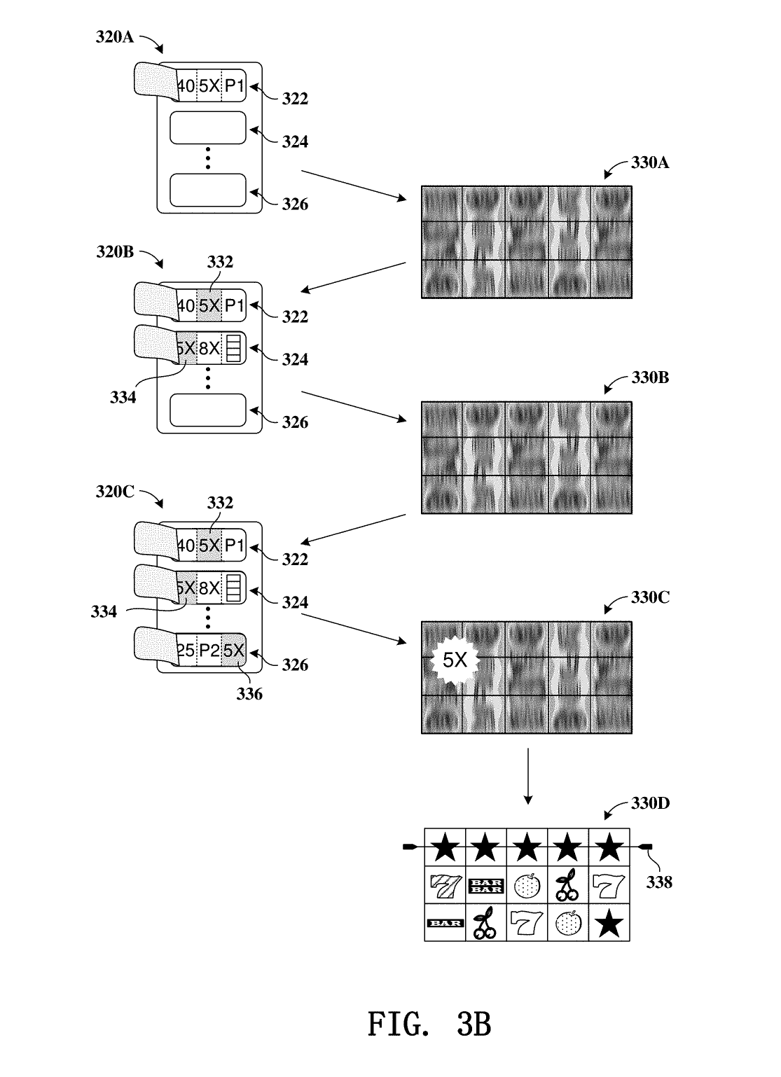

FIG. 3A is a block diagram where electronic or “virtual” scratch cards are used to identify awards, award modifiers, etc. When a game begins, the player is presented with a depiction of a scratch card 300A with some number of scratch-off areas 302. In one embodiment, there are nine scratch off areas 302 on the scratch-off card 300A, although any number may be implemented. In one embodiment, on each reel spin or other slot game symbol randomization, such as first reel spin 304A, one of the scratch-off areas 302 on the scratch card is “scratched” to expose its underlying indicia, revealing an award in one embodiment, or revealing a progression towards an award in other embodiments. For example, in one embodiment, each scratch-off card 300A includes three different award modifier types, and on each reel spin, one of the spots on the scratch-off card is scratched revealing one of the three modifier or award types, which may be selected from a larger pool of modifier/award types. In the example of FIG. 3, the three types are generically identified as T-1, T-2, and T-3.

On reel spin 304A, a scratch-off area 302 may be scratched (which in an electronic embodiment may mimic scratching a layer off, or just remove anything hiding the underlying indicia, etc.), revealing a T-1 type 306 in this example. Because the present example involves receiving three of the same type before it is awarded, no award or modifier is available at the stage represented by scratch-off card 300B. Another spin occurs as depicted by grid 304B, and another scratch-off area 302 is scratched as shown at scratch-off card 300C, which reveals a T-3 type 308. This continues until three of the same modifier type have been revealed, as depicted at scratch-off card 300D, where three T-1 types 306, 310, 312 have been revealed. The T-1 type of award/modifier is then applied to a game result, such as the next spin, shown at grid 304D. In the example grid 304D, a payout on payline 314 is provided, and assuming the T-1 type award/modifier is a multiplier, it then enhances the payout on payline 314 by multiplying the payout by the awarded multiplier. Thus, in this embodiment, once the player has revealed three of the same modifier type, that modifier is applied to the next spin, and a new card may be presented.

Representative item types include, for example:
1. Spin multiplier (e.g., 5×, 10×, etc.)
2. Symbol stacks
3. Symbol Conversion (e.g., F9 symbol to Wild symbol)
4. Special boosted Paytable
5. Reduced criteria bonus trigger
6. Guaranteed win
7. (etc.)

In one embodiment, the scratching action is automatic and provided by the game, while in other embodiments the player may be allowed to select the desired scratch-off areas 302 in which to reveal the underlying symbol/indicia. Enabling player participation in this regard may increase player interactivity, where touching the scratch card (or using user inputs to designate areas on the scratch card) reveals the underlying item and in some embodiments also initiates a reel spin. In other embodiments, the player may use the regular spin buttons, where the scratch location is randomly selected by the game, or the player can otherwise select the order of scratched areas.

Any type of gaming “ticket” may be used as the vehicle for revealing the progression towards a granted benefit to the player. Physical or electronic/virtual pull tabs, display boards, textual lists, and/or any other manner of displaying and tracking symbols and their respective revealed quantities may be used. For example, a multi-item pull tab may serve an analogous purpose as a multi-item scratch card, or multi-item display board, or maintained textual list of symbols, etc. This is exemplified in FIG. 3B, which illustrates a multi-item pull tab embodiment used to identify awards, award modifiers, etc., in the context of a slot game.

The player is presented with a depiction of a pull tab 320A with some number of pull tab segments 322, 324, 326. One (or more in other embodiments) of the pull tab segments 322, 324, 326 may be exposed, whether by system selection or player selection of one of the pull tab segments 322, 324, 326. In the illustrated embodiment, pull tab segment 322 has been selected to be revealed. In this embodiment, multiple symbols or other indicia are revealed when the pull tab segment 322 is opened, and any number between zero and a desired maximum may be associated with a “pulled” tab. In this embodiment, there are three symbols that are exposed with each pulled tab segment.

In one embodiment, some number of minimum matching symbols are accumulated before a corresponding award is provided. For example, a pull tab segment 322, 324, 326 of the pull tab 320A may be revealed on each slot game reel spin, or pull tab segments 322, 324, 326 may be randomly revealed on just some of the reel tab spins, or may be revealed in response to some other event associated with the slot game (e.g., a sub-symbol, special symbol, symbol combination, and/or other event occurred), etc.

For purposes of example, it is assumed in the illustrated embodiment that a pull tab 320A segment 322, 324, 326 is “pulled” to reveal the underlying symbols on each reel spin, whether the player or system selects one of the segments 322, 324, 326. It is also assumed that an accumulation of three like symbols over the course of a plurality of reel spins or other gaming events we'll result in the granting of a player benefit identified by the matching symbols.

In FIG. 3B, pull tab segment 322 is opened in connection with reel spin 330A, and reveals three pull tab symbols which may include credit values, multiplier or other modifier values, progressive jackpot awards (e.g., P1 may represent a top level progressive award), etc. Since there have not yet been three like symbols revealed with this pull tab 320A, further spins and pull tab segment revelations occur. Another pull tab 320B may be provided in connection with the next (or later) reel spin 330B, where another pull tab segment 324 is opened, revealing more pull tab symbols. In this example, there are now two matching symbols 332, 334 from pull tab segments 322, 324 respectively, which in this example are five-times-multipliers (5X) that can be used to increase a slot game payout by a factor of five if and when the requisite number of like symbols are presented. Another pull tab 320C may be provided in connection with reel spin 330C, where yet another pull tab segment 326 is opened, revealing still more pull tab symbols. Another 5× symbol 336 from pull tab segment 326 is revealed, thereby meeting the current example's requirement of three matching symbols, in which case the 5× multiplier is awarded. The awarded multiplier, or any payout modifier, may be applied, for example, to specific portions of a reel spin (e.g., one or some subset of paylines) or to all payouts. In this embodiment, the 5× multiplier is applied to any payouts occurring on the current reel spin 330C, shown as a completed reel spin 330D, where a payout is provided for receiving five like slot game symbols (i.e. stars in this example) on payline 338. Thus, if the reel spin 330D payout on payline 338 was 100 credits, the total credit award would be 500 credits (100 credits times 5). In one embodiment, pull tab segments may continue to be pulled as many times as needed to reach a qualifying number of like symbols in which to present an award, while in other embodiments the qualifying number of like symbols must occur within a predetermined number of pull tab segments or an award will not be provided for that pull tab.

FIG. 3B therefore illustrates a representative embodiment in the context of pull tabs having multiple selectable items associated therewith. The game may maintain a pull tab-style barrel or bin that holds payout modifiers, payouts, increased value events, and the like, that are shown to the player. In one embodiment, on random reel spins (or other gaming events), a pull tab may be randomly provided from the barrel for use in determining gaming payouts. In other embodiments, the chance is provided on every reel spin, or reel spins during a certain event, etc. In one particular embodiment, the pull tabs in the barrel each have a payout multiplier associated therewith, as was the case in the example of FIG. 3B, and one or more pull tabs may be randomly obtained from the barrel for use in modifying payouts from the symbol combinations or other payout events associated with the reel spins.

Various types of awards, award modifiers, reel enhancements, and other player benefits may be provided in connection with the ticket-based awards disclosed herein. FIGS. 3A and 3B depicted embodiments where payout modifiers (multipliers) were awarded. FIG. 3C depicts an example where virtual scratch cards are used to identify a guaranteed slot game result, which implements a forced result feature described more fully below.

In the example of FIG. 3C, the player is presented with a depiction of a scratch card 340A with some number of scratch-off areas. In the illustrated embodiment, there are nine scratch off areas on the scratch-off card 340A, although any number may be implemented. In one embodiment, on each reel spin or other slot game symbol randomization, such as first reel spin 350A, one of the scratch-off areas on the scratch card 340A is “scratched” to expose its underlying indicia, revealing a star symbol 342, representing a symbol that will be used in a forced reel spin result if the qualifying number of such star symbols are uncovered on the scratch card. In one embodiment, the symbol 342 may also include a number, to identify what type of forced result would occur with that symbol—i.e. a number “3” would indicate a 3-pay result (3 star symbols), a “4” would indicate a 4-pay (4 star symbols), etc. In the illustrated embodiment, the star symbol includes a number “5,” indicating that if the qualifying number of such star symbols 342 was to occur, a reel spin would be forced to generate a “star 5-pay” result, meaning a winning star symbol combination with five symbols (e.g., five consecutive star symbols along a payline; a five-symbol scatter symbol using the star symbol; etc.).

Because the present example involves receiving three of the same type before it is awarded, no award or modifier is available at the stage represented by scratch-off card 340A. Another spin occurs as depicted by grid 350B, and another scratch-off area is scratched as shown at scratch-off card 340B, which reveals another star symbol 344. This continues until three of the same symbol have been revealed (in this embodiment), as depicted at scratch-off card 340C, where three star 5-pay symbols 342, 344, 346 have been revealed. Therefore, the award provided via the scratch card 340C is a particular slot game outcome, which then is forced on the current or a subsequent slot game reel spin. In one embodiment, the grid 350C may represent the current reel spin, where the reels did not yet provide a result while the scratch card 340C was presented and resulted in a star 5-pay result, in which case that result is applied on the current grid 350C to provide the star 5-pay as seen on payline 348 of grid 350D. In another embodiment, the grid 350C may represent the next (or later) reel spin, where symbols may be presented on the grid 350C on a current spin, and the 5-pay result is applied in connection with the next reel spin event depicted by grid 350D, where the star 5-pay is forced on a payline (payline 348 in this example). The forced result may be provided in any desired place on the grid 350D, or may be positioned according to rules for such forced results.

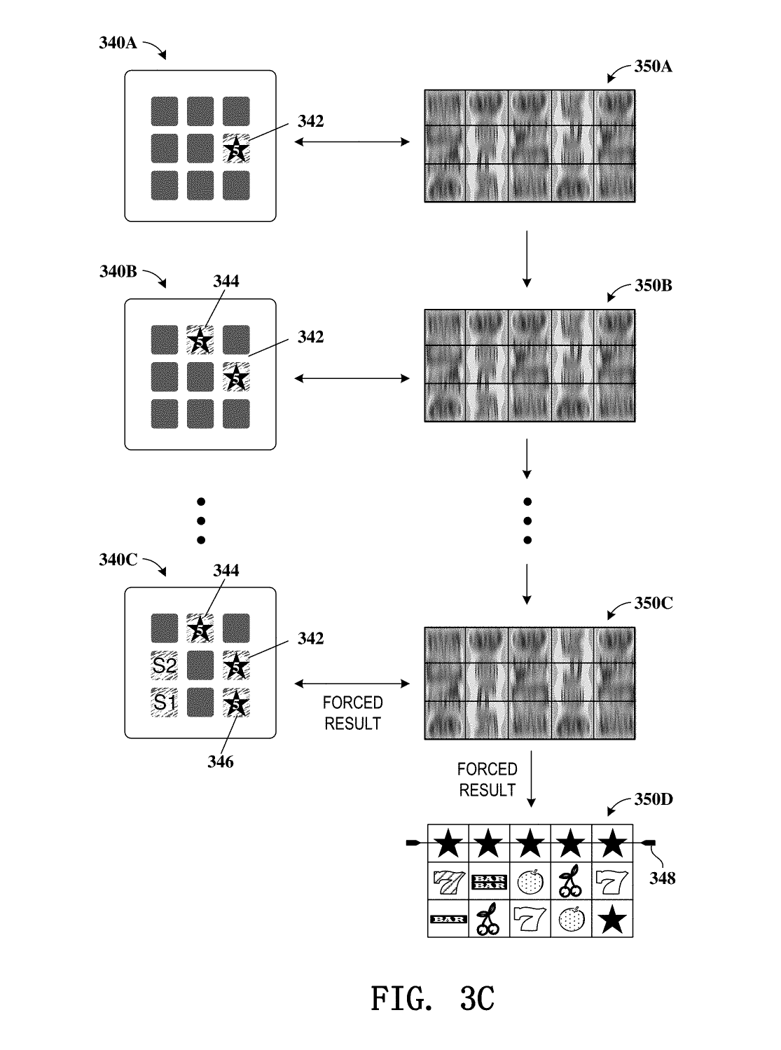

FIG. 4 is a flow diagram depicting an embodiment of an interevent progression towards the awarding of a gaming asset to a gaming participant. The embodiment of FIG. 4 may involve a main or primary gaming event itself, or may serve as a secondary or auxiliary award-generating feature in addition to one or more primary or other gaming events. A game play ticket is configured 400 with multiple hidden symbols, where in one embodiment each symbol has at least one way in which to grant a player asset. For example, each game play ticket (e.g., physical or virtual scratch-off card, pull tab, display board, etc.) may have at least one winning symbol combination thereon, and the player may be awarded an award if the winning symbol combination is revealed before some other combination, pattern, quantity, etc. is revealed on the card. In another embodiment, the player will be awarded the winning symbol combination once it is revealed in its entirety, regardless of whatever else is revealed on the game play ticket, which results in randomly staggering when the player will receive the award if the player just continues to play the game and uncover further items. In another embodiment, not every game play ticket has a winning symbol combination or other notification thereon, whereby a player could play out a game play ticket and not be awarded any player asset for exhausting all symbols on the respective game play ticket. However, in the illustrated embodiment of FIG. 4, the embodiment assumed includes at least one winning symbol combination (including a single, special symbol, or mystery symbol, or stated credit value, etc.).

The configured game play ticket is presented 402 to the player. The game play ticket may be presented before initiation of the gaming event (e.g., before a slot game reel spin), during a randomization of gaming symbols or during other pre-result gaming activity (e.g., during a slot game reel spin), as gaming event results are being presented (e.g., during slot game reel stoppage and symbol placement), after the gaming event results have been presented (e.g., after the slot game reels have stopped spinning), etc.

In accordance with one embodiment, one of the symbols (perhaps more symbols in other embodiments) that is hidden by the game play ticket is revealed 404. For example, in connection with the reel spin, one of the selectable items on a virtual scratch card may be automatically/randomly selected by the gaming system, and revealed. In another embodiment, the game play ticket may be presented such that it facilitates player selection of one of the selectable items, such as via a touch screen, user input, etc.

In connection with the newly revealed symbol associated with the game play ticket being exposed, it may be determined 406 whether a qualifying number of same ticket symbols have now been revealed. For example, assume a game play ticket (e.g., virtual scratch card) that has at least one winning symbol configuration of three matching symbols to award a progressive jackpot (P1). The qualifying number would be three, and the same ticket symbols would be P1 symbols. If three such matching symbols have not been revealed on the game play ticket over some number of gaming events (e.g., over a span of multiple reel spins), then no award is provided, and the game play ticket may again be presented 402 in connection with another subsequent reel spin or other gaming event. On the other hand, if it is determined 406 that the qualifying number of like ticket symbols has been revealed, then an award for the occurrence of that qualifying number of same ticket symbols being revealed is provided 408. In one embodiment, more than one award may be available on the same ticket, in which case the game play ticket may again be presented 402 in connection with another subsequent reel spin or other gaming event as depicted by the dashed line from block 408 to block 402. In another embodiment, a game play ticket may be configured to only have one winning possibility thereon, or may only allow one of a plurality of winning possibilities to be awarded, in which case providing 408 the award then results in starting anew by configuring 400 a new game play ticket. In various embodiments, the ticket may be played until one winning outcome is presented via the game play ticket, or until all winning outcomes are presented, or until all symbols are revealed, or until any other defined termination event occurs thereby indicating that the game play ticket has expired in these or other manners, in which case a new game play ticket may be provided if the game rules provide for it.

Thus, in accordance with one slot game embodiment relating to the embodiment of FIG. 4, methods may be provided for providing payout modifiers, reel enrichments, direct credit awards, jackpots, or other desired player assets in a slot game. A virtual scratch-off card, pull tab, or other multi-item element with hidden symbols yet capable of individual symbol revelation may be configured to have at least one winning possibility thereon. The scratch-off card or other element may be presented in association with a reel spin event, and one (or more in other embodiments) of the hidden symbols are exposed. If a winning combination of the symbols occurs as a result of a qualifying number of matching symbols/indicia being exposed, an award is conferred based on which winning combination of symbols met the qualifying criteria. For example, if a qualifying number of P1 progressive jackpot symbols has been revealed over a plurality of such slot game spin events, then the award that corresponds to the P1 progressive jackpot will be awarded. If no winning combination of the symbols has yet been exposed on the virtual scratch-off card or other game play ticket, then additional symbol revelations may continue until an award is won, or all symbols have been exposed on the ticket, the player stops playing before all symbols have been exposed, etc.

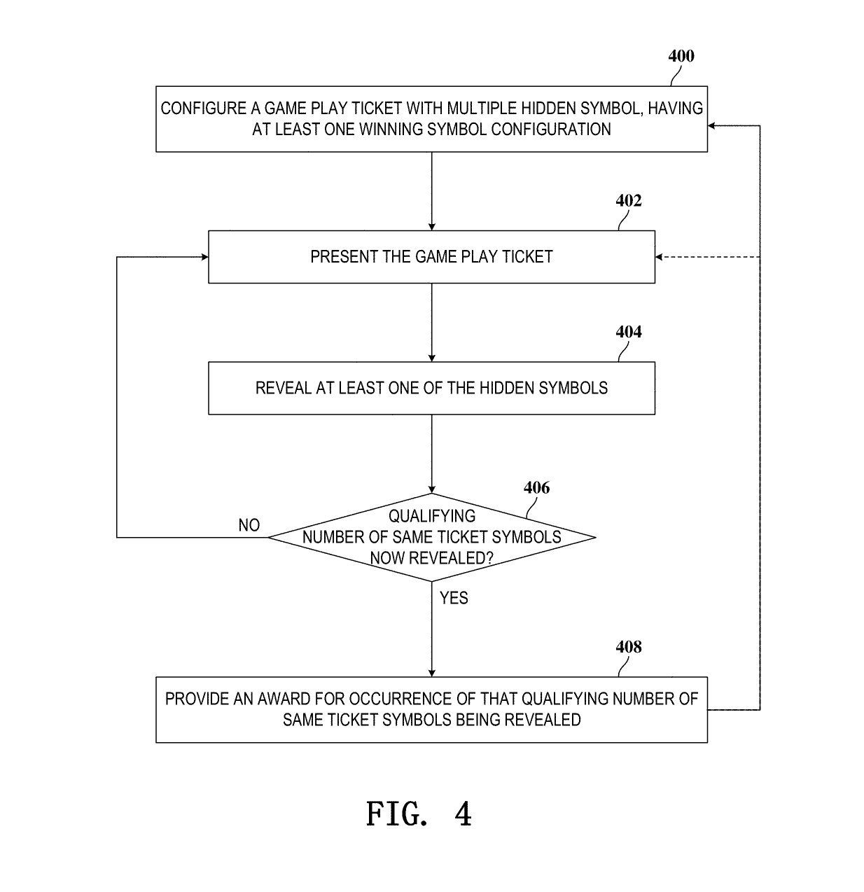

FIG. 5 illustrates a representative embodiment of an operational arrangement of a gaming device that beneficially provides gaming participants with manners of envisaging approaching opportunities to enhance gaming payouts. The representative embodiments of FIG. 5 and other embodiments described herein may be implemented using processing hardware, storage, software, etc. FIG. 5 depicts embodiments where a processing arrangement (e.g., single processors, multiple processors, or any other processing arrangement) is programmed with software and/or firmware to provide various modules to perform functions described herein.

The representative gaming device 500 tracks and provides information to players regarding impending, yet at least somewhat indefinite, awards of payout enhancements or grants of other play-related assets. In the illustrated embodiment of FIG. 5, the symbol-based result being tracked is the occurrence of some award, or progression towards an award, as tracked and determined over multiple reel spin events (or other gaming events, depending on the game and associated rules).

For purposes of this example, a “ticket” will the assumed to correspond to any multi-item element, including but not limited to physical or virtual scratch cards, pull tabs, display boards, text and/or audio symbol indications, and/or any other manner of presenting an interevent progression of symbols. A ticket configuration module 502 corresponds to the hardware, firmware and/or software involved in generating the ticket 504, which may be presented via the display 506. The ticket may be represented by, for example, a X-symbol scratch card 504A, multi-item pull tab 504B, etc., which in one embodiment includes at least one winning combination of symbols originally hidden thereon.

The current state of the scratch card may be maintained and made known to the player, such as by displaying the symbol revelation progress on the ticket 504 via the display 506. The display 506 may also present a gaming event 508, such as a primary gaming event, which is a slot game 508A in the current example, where the slot symbol selection module 509 selects symbols for presentation via the slot game 508A array. In connection with participation in the slot game 508A, the ticket item selection module 510 identifies one (in one embodiment) of the symbols on the ticket 504 to expose. The determination may be made by the system, and the system or the player may determine which of the symbol locations on the ticket 504 to reveal.

The ticket analysis module 512 may be coupled to the ticket item selection module 510 to recognize the symbols that have been revealed, and to determine whether a qualifying number of symbols on the ticket 504 have been exposed and formulate a winning result. In some cases, a single exposed symbol may formulate a winning result, such as in embodiments where the ticket is progressively revealed over a number of gaming events, yet a combination of symbols is not required, but rather a single symbol may present an award, award modifier, reel enrichment, etc.

Where the ticket analysis module 512 determines that no qualifying symbol or symbol combination has occurred, the ticket item selection module 510 may reveal another symbol(s) on a subsequent spin of the slot game 508A. This inter-spin or other interevent symbol selection may continue until the ticket analysis module 512 determines that a qualifying number of like symbols (in the case of a multi-symbol winning combination) have been exposed on the ticket 504. At such time, the award enhancement module 514 can provide the award corresponding to the qualifying symbol result determined via the ticket analysis module 512.

As noted elsewhere herein, the award provided as a result of the ticket 504 meeting some award condition may be various types of awards. In one embodiment, the symbol or symbol(s) combination qualifying for the award may result in an upgrade or enrichment to the current or future gaming events 508. For example, rich symbols (RS) 516 may be awarded for the current slot game 508A spin or one or more subsequent slot game 508A spins, such as an increased quantity of high value symbols, a higher proportion of high value symbols, conversions of lower value symbols into higher value symbols, stacks of symbols, increased paytable payouts for one or more slot game 508A spins, reduced criteria to reach certain results (e.g., reducing the number of matching symbols needed to get a bonus event), or the like. Such rich symbols 516 and other criteria plays into the gaming event 508, such as the slot game 508A, and therefore may impact the current slot game 508A or one or more subsequent slot games 508A.

The award enhancement module 514 may instead or additionally provide award modifiers, such as payout modifiers (M) 518. Payout modifiers 518 may increase or otherwise enhance payouts occurring in connection with another portion of the gaming activity, such as payouts provided in connection with the slot game 508A. One example of such a modifier 518 is a multiplier, which can be multiplied by a payout occurring in the slot game 508A. Thus, where the primary award identification module 520 determines from (for example) the slot symbol selection module 509 that a payout(s) occurred during play of the slot game 508A, that payout(s) may be increased by the modifier (M) 518 identified as a result of the ticket 504 exhibiting revealed symbols that result in a payout modifier.

In another embodiment, the symbols resulting in the award as determined by the ticket analysis module 512 and facilitated by the award enhancement module 514 may be a direct award 522 that can be awarded on the current gaming event 508 or a subsequent gaming event 508. For example, a progressive jackpot may be won as a result of a qualifying number of like symbols being presented on the ticket 504. Other guaranteed wins may be provided, such as a high value symbol combination (e.g., a five-symbol combination on a payline of a high value symbol). Another example of a guaranteed win may be a bonus event, free games, etc. Such forced or guaranteed wins may be accomplished in any desired manner suitable, while maintaining the mathematical payout probabilities at a desired point or within a desired range. An example of such a forced win concept that may be used in connection with providing such awards (A) 522 is described below.

In cases where the award enhancement module 514 has not provided any award 516, 518, 522, then any award 524 identified by the primary award identification module 520 from activity occurring in connection with the slot game 508A may be provided, as part of the standard/primary gaming event 508. However, the award 524 may in fact be enhanced in some respects, in the event that rich symbols 516 or other gaming event-based benefits are afforded to the slot game 508A, thereby making the award 524 more likely, and/or a higher payout, etc.

When a modifier 518 is provided and applied to a payout identified via the primary award identification module 520, an enhanced award 526 results. If an award 522 is provided, if it is a direct credit value or other direct benefit, it may be added or otherwise associated with the outcome of the primary award identification module 520 to provide an enhanced award 526. In other embodiments, where the award 522 represents a guaranteed win (e.g., a progressive jackpot, a winning symbol combination, a bonus event, a free games event, etc.), then it may direct the slot symbol selection module 509 to cause an outcome.

As noted above, some awards are provided in the form of a guaranteed outcome, such as a guaranteed win of a particular symbol combination, progressive jackpot, bonus event, etc. Forcing results or otherwise causing particular results to occur may be accomplished as set forth herein, and/or as described in co-pending U.S. patent application Ser. No. 16/031,289, filed on Jul. 10, 2018, and entitled “Systems and Methods for Overriding Gaming Results,” the content of which is incorporated herein by reference in its entirety. Other manners of causing results to occur in slot games, poker games, and other gaming activities may also be used in connection with the teachings described herein as will be readily apparent to those skilled in the art from the teachings provided herein.

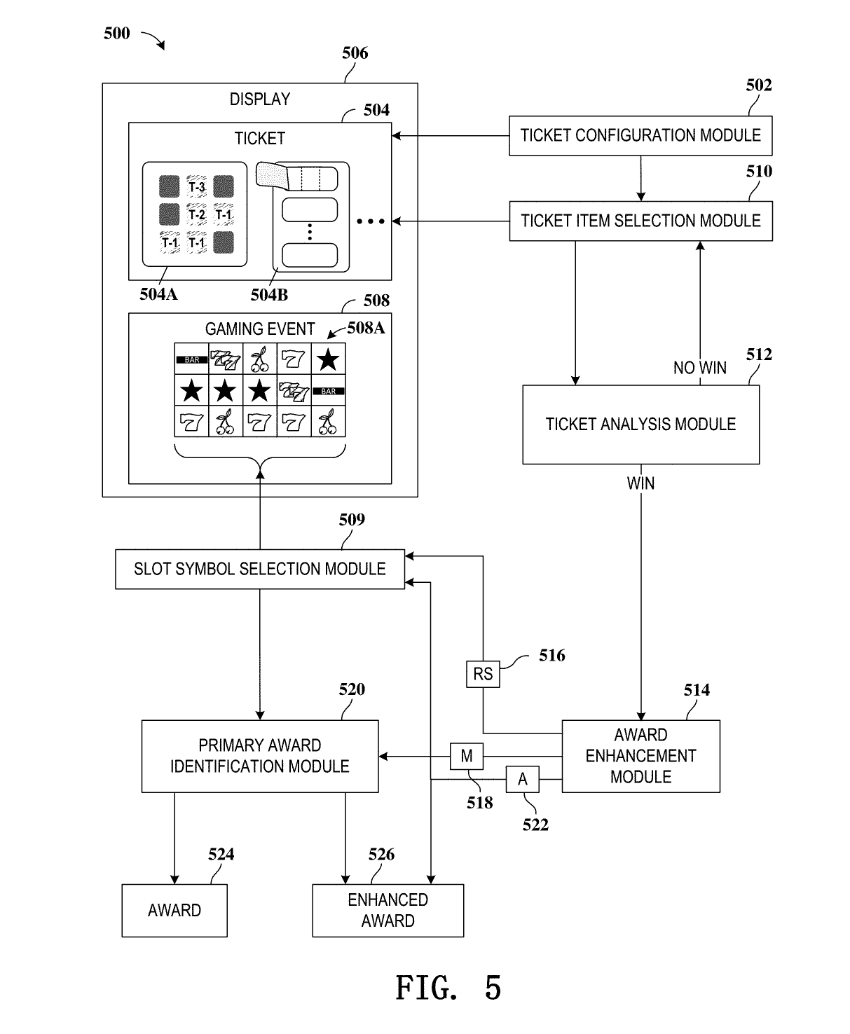

For example, one manner of overriding gaming results is depicted in FIG. 6, where a random selection is made to either enable the natural outcome of a gaming event to occur, or to select from a table, bank or other repository of gaming event outcomes at a desired frequency. The “frequency” of selection from the table, bank, etc. may be temporarily set to ensure that an override outcome will occur.

In the embodiment of FIG. 6, a gaming event is initiated 600, such as physically or virtually spinning slot reels, dealing a poker hand(s), spinning a roulette wheel, identifying selected keno numbers, or any other start of a gaming event. A random selection 602 takes place to randomly determine whether the gaming event natural outcome 604 is allowed to occur, or whether an override outcome 606 will be used instead of the natural outcome 604 of the gaming event. For example, the random selection 602 may be configured to enable the natural outcome 604 to occur X % of the time, and to enable a predefined override outcome 606 to occur Y % of the time.

In one embodiment, there may be just one override outcome 606, such that the random selection 602 selecting the override outcome 606 Y % of the time will cause the single override outcome 606 to be the gaming event outcome Y % of the time. In other embodiments, the override outcome 606 represents a plurality of selectable, predefined gaming event outcomes. Therefore, when the random selection 602 determines that the override outcome 606 will occur Y % of the time, one of the plurality of selectable, predefined gaming event outcomes associated with the override outcomes 606 will be selected. For example, the override outcomes 606 may include a plurality of top awards, and/or other combinations such as a top award and a modifier (e.g., multiplier), etc. in this manner, the natural outcome 604 can be overridden by the random selection 602 and outcome selection within the override outcomes 606. In either case, a payout 608 may be provided in the event that the natural outcome 604 resulted in a winning outcome, or in the event that the selected (or sole if only one) outcome associated with the override outcome 606 has a payout 608 associated therewith.

The weight associated with the random selection 602 is, in one embodiment, adjustable. A static setting 610 may be provided to set the random selection 602 at a particular weighting of natural outcomes 604 and override outcomes 606. In other words, the static setting 610 may enable the random selection 602 to set the percentages, X % and Y %, in which the natural outcome 604 and override outcome 606 will be selected. As an example, the static setting 610 may be set to cause the random selection 602 to cause the natural outcome 604 to be selected 99.9% of the time, while causing the override outcome 606 to occur 0.1% of the time. Where there are multiple predefined gaming event outcomes associated with the override outcomes 606, at least one of those predefined gaming event outcomes will be selected when the random selection 602 allows the override outcome 606 to be utilized. In one embodiment the allocation between natural outcomes and predefined outcomes is set, yet the setting may be adjusted to “re-set” the fixed allocation.

The weight associated with the random selection 602 is, in another embodiment, dynamically adjustable during play of the game. A dynamic setting 612 may be provided to set the random selection 602 at a first weighting of natural outcomes 604 and override outcomes 606, which can change throughout play of multiple gaming events. In other words, the dynamic setting 612 may enable the random selection 602 to adjust and readjust the percentages X % and Y % during play, such as when the award enhancement module 514 of FIG. 5 calls for a guaranteed win on the current or a subsequent slot game 508A as a result of the ticket 504 indicating such a guaranteed win.

As an example, the dynamic setting 612 may temporarily be set (e.g., for one reel spin) in response to a guaranteed win request, to cause the random selection 602 to cause the natural outcome 604 to not be selected, and the override outcome 606 to occur 100% of the time, for that particular spin or other gaming event. When some event or threshold occurs, such as the ticket analysis module 512 determining that a qualifying number of like symbols has identified a guaranteed win event via the slot game event 508A, the dynamic setting 612 can cause the weighting between the X % and Y % to be readjusted, such as causing the override outcome 606 to occur on the next random selection 602.

Thus, in one embodiment, the award enhancement module 514 may facilitate providing a guaranteed result or award 522, which uses a random selection module 602 or analogous module to force that guaranteed result or award 522. The award enhancement module 514 therefore may invoke a forced win function, such as that depicted in FIG. 6. In one embodiment, the award enhancement module 514 identifies the guaranteed award 522, and causes the dynamic setting 612 to set the override outcome 606 to ensure that guaranteed award 522 occurs before the end of the current reel spin event or for the next (or later) reel spin, depending on the desired rules of the game.

As noted above, forcing results may be accomplished as set forth herein, and/or as described in co-pending U.S. patent application Ser. No. 16/031,289, filed on Jul. 10, 2018, entitled “Systems and Methods for Overriding Gaming Results,” the content of which is incorporated herein by reference in its entirety, and/or based on other manners of forcing or guaranteeing a result when indicated or otherwise desired.

Forcing results in such manners enables guaranteed results to be provided in connection with the scratch cards and other award tickets described herein. Payout modifiers and reel enrichment may, in some embodiments, be applied to current (or future) results, where the reels are changed and/or payouts are increased, but guaranteed wins/results may require an ability to set a particular result(s) at a particular time. Additionally, ticket awards having small or mid-sized awards may also be forced in connection with the scratch card concept to allow the win probabilities and corresponding payouts to remain at a desired level or within a desired range. Thus, a forced result methodology as set forth herein, or other forced result methodologies similarly enabling results to be caused in the desired manner and at the desired time, enable such award tickets to be used as such forced results can cause particular reel spin results or other gaming results when awarded.

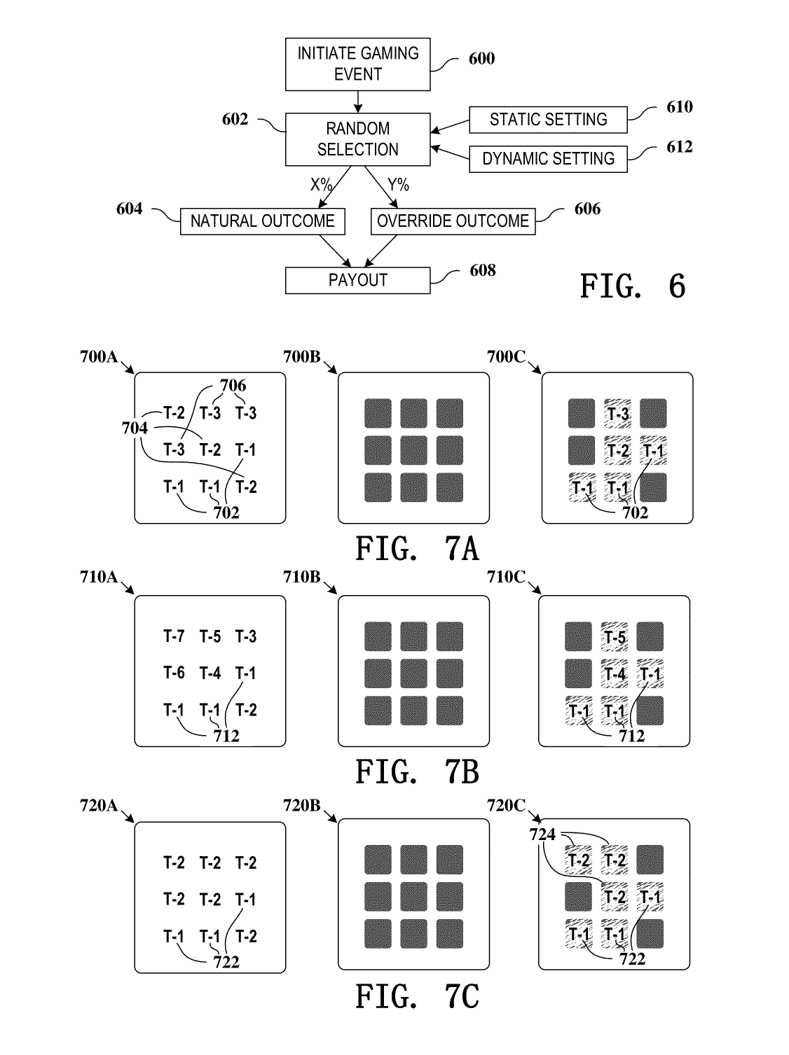

Scratch cards, multi-item pull tabs, and other tickets described herein may be configured (e.g., by ticket configuration module 502) to have various types of potential winning combinations and chances relative to other symbols on the ticket. FIGS. 7A-7C depict a few representative examples of how a qualifying number of matching symbols may be configured onto the scratch cards or other tickets. While the description applies to any tickets, the embodiments of FIGS. 7A-7C are described in terms of virtual scratch-off cards, where (at least) one hidden area is exposed in connection with consecutive, or in other embodiments nonconsecutive, reel spins or other gaming events.

FIG. 7A depicts a scratch card 700A that is depicted as having nine selectable items, although the principles described herein are equally applicable to tickets having any number of selectable items. In the embodiment of FIG. 7A, a plurality of winning symbol combinations are configured on the scratch card 700A. In one embodiment, any of the plurality of winning symbol combinations may ultimately be awarded to the player, where some of the winning symbol combinations may be of more value than other winning symbol combinations on the scratch card 700A. In this embodiment, three different symbol types populate the scratch card 700A, including symbols T-1 702, T-2 704, and T-3 706. Symbol types could be identical symbols, or may be of a common type (e.g., multiplier) that in some embodiments constitutes “like symbols” even where there are some differences (e.g., multiplier amount). The symbols are hidden as depicted at scratch card 700B, and then individual symbols are revealed during play of the game as depicted by scratch card 700C. In the embodiment of FIG. 7A, the first symbol selected the qualifying number of times (i.e. three in this example) will be awarded to the player, as depicted by the selection of three T-1 symbols 702 at scratch card 700C. Thus, such an embodiment may be considered a race to the qualifying number of one of the symbols populated on that scratch card, whereby the player could win any of a plurality of awards depending on which symbol reaches the qualifying count first. In an alternative embodiment, the player could keep using the same scratch card 700C to ultimately win all of the plurality of awards provided thereon, before obtaining a new scratch card 700A.

FIG. 7B depicts a scratch card 710A that is again depicted as having nine selectable items, where there is only one potential winning symbol combination (or winning symbol/indicia) associated therewith. In the illustrated example, there are three T-1 symbols 712, which if/when revealed, will award the award associated with the qualifying number of T-1 symbols. The player could reveal the winning combination of T-1 symbols 712 as soon as the third scratch-off (e.g., on three reel spins, symbols 712 could be revealed), or could reveal the winning combination of T-1 symbols 712 as late as the 7^{th}, 8^{th} and 9^{th} (on a 9-symbol ticket) scratch-offs. Thus, in such an embodiment, the player may ultimately obtain the award associated with the qualifying number of T-1 symbols, but the faster the qualifying number is reached, the sooner another opportunity to get another award with another new ticket 710A arises.

FIG. 7C depicts another representative scratch card 720A where there is one set of potential winning symbols, such as three T-1 symbols 722, and the rest the same (or some different) symbols that will not provide an award if the qualifying number is reached first. For example, if the player uncovers three T-1 symbols 722 before uncovering three T-2 symbols 724, the player wins the award corresponding to uncovering the three T-1 symbols 722.

Alternatively, if the player uncovers three of the six T-2 symbols 724 before uncovering three T-1 symbols 722, the player will not win the award. In one embodiment, once the award is not won due to first obtaining three of the “non-award” symbols (e.g., T-2 symbols 724 in this example), a new scratch card 720A is again provided without any award granted to the player.

The examples of FIGS. 7A, 7B, and 7C are representative of the various manners in which scratch-off cards and/or other multi-item tickets may be configured in accordance with the principles described herein, however other configurations are equally applicable in view of the teachings set forth herein. For example, “symbols” on the scratch-off cards 700A, 710A, 720A could include blank symbols providing no advancement towards a winning or losing combination. In another example, “stop” symbols or other termination notices could be included, such as where multipliers are awarded as they are selected until such a stop/termination symbol is provided. From the teachings set forth herein, these and other symbol configurations are within the scope of the disclosure, and are comprehensible to those having ordinary skill in the art.

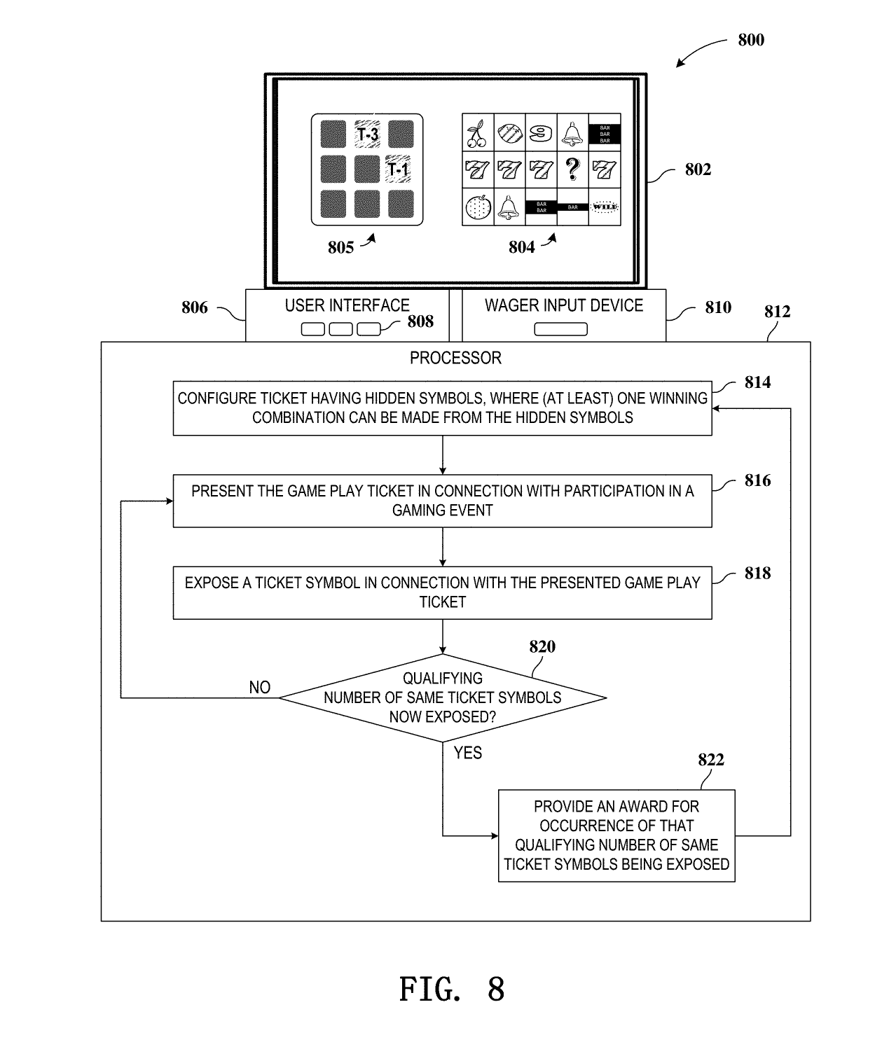

FIG. 8 is a block diagram of a representative gaming apparatus for enhancing payouts by tracking gaming occurrences in gaming activities. In the embodiment of FIG. 8, a symbol-based gaming apparatus (e.g., slot game device) 800 is provided on which players can play slot games. Other games may instead be used as a primary game, such as poker, or other games involving symbols or indicia in the determination of winning results. The representative slot game device 800 includes at least a display(s) 802 presenting a slot game symbol array or “grid” 804 of symbols, as well as presenting a status 805 of current revealed symbols. A user interface 806 is provided that includes at least one user input 808 to enable a player to initiate and participate in slot game events presented via the slot game grid 804, and a wager input device 810 structured to identify and validate player assets and ultimately permit the player to play the slot game event when the player assets are provided.

A processor 812 is configured to configure 814 a ticket(s) having hidden symbols, where at least one winning combination can be made from the hidden symbols. The processor 812 can direct the display 802 to present 816 the game play ticket in connection with participation in a gaming event, such as the slot event shown at slot game symbol array 804. The processor causes a ticket symbol(s) to be exposed 818 in connection with the presented game play ticket. If it is determined 820 that a qualifying number of same ticket symbols have not been exposed, then the game play ticket may again be presented 816 in a subsequent gaming event (e.g., provided again on a next or later reel spin). If it is determined 820 that a qualifying number of same ticket symbols have been exposed, then an award corresponding to that qualifying number of symbols is provided 822. In some embodiments, once an award has been provided 822, a new ticket is configured 814 to repeat the process.

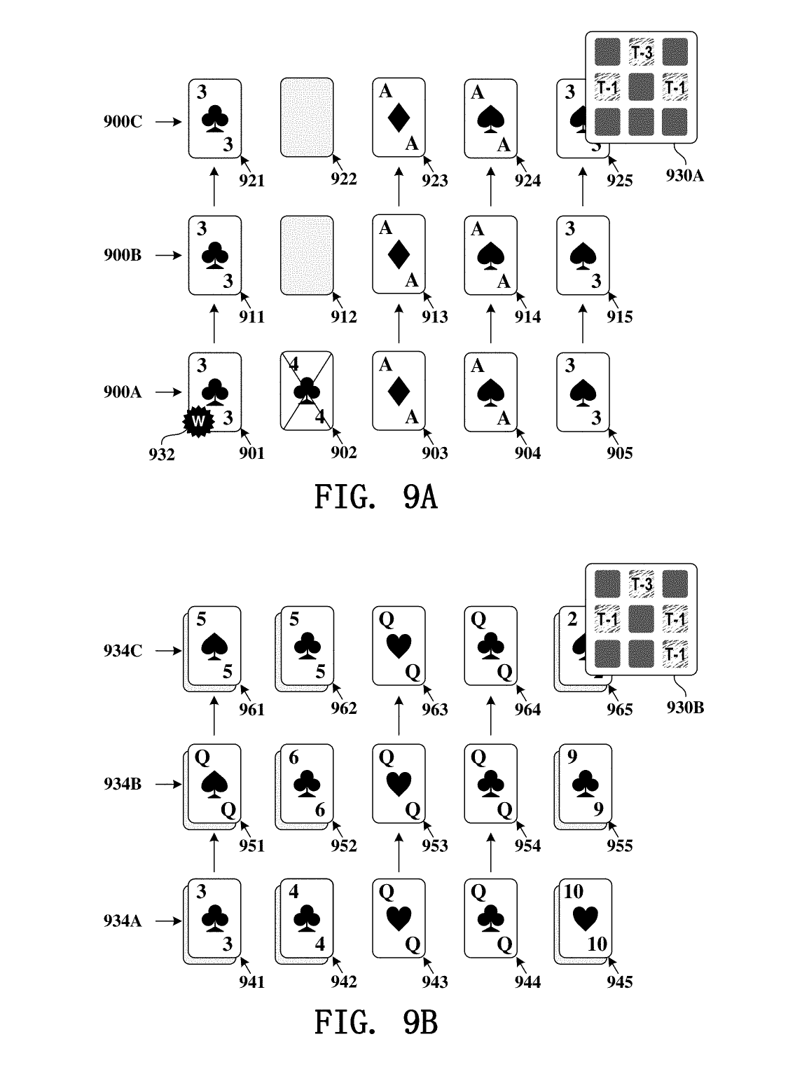

The principles described herein are equally applicable to other gaming events, whether associated with a primary gaming event(s) or a secondary gaming event(s). FIGS. 9A and 9B are described in the context of an electronic poker embodiment. The poker embodiment may involve a single hand, or may be a multi-play embodiment where one or more additional hands are played, where there is involvement between the multiple hands or whether each of the multiple hands is played independently. The representative embodiment of FIG. 9A depicts an electronic, multi-play, poker game embodiment involving three concurrently-played hands 900A, 900B and 900C associated with a first gaming event (poker deal), although as few as one hand 900A could be played, and as many more than three hands as desired.

FIG. 9A in this example represents a first poker event being played, that includes a first, original hand 900A, and one or more additional hands 900B, 900C. The first hand 900A is dealt, including, in this example, cards 3-Clubs, 4-Clubs, Ace-Diamonds, Ace-Spades, and 3-Spades at card positions 901, 902, 903, 904 and 905 respectively. Hand 900B includes card positions 911-915, and hand 900C includes card positions 921-925. In accordance with one embodiment of multi-play draw poker, in which the present example assumes, cards held in one hand 900A are replicated into the other hands 900B, 900C.

In connection with the played poker hands, whether a single hand 900A or multiple hands 900A, 900B, 900C, a scratch card 930A or other analogous ticket may be presented. The scratch card 930A may be presented randomly, or may be presented on each new poker hand played, or may be presented if some other indicator occurs such as a sub-symbol(s) 932 on one or more cards, etc. In the illustrated embodiment of FIG. 9A, the scratch card 930A is assumed to not yet reveal a qualifying number of like symbols in which an award or other player benefit is awarded.

On a following hand depicted in FIG. 9B, the scratch card 930B is presented, where another symbol has been revealed. Three T-1 symbols have been exposed on the scratch card 930B, and assuming that three T-1 symbols qualifies for an award, and award would be provided. For example, if the T-1 symbol combination was defined to provide a 10× multiplier, then the 10× multiplier would be applied to any winning payouts from hands 934A, 934B, 934C. In some embodiments, any award (e.g., 10× multiplier) would be applied to all winning payouts associated with the hands 934A, 934B, 934C, while in other embodiments it may be applied to some subset thereof, and/or to subsequent hands, etc.

The foregoing description of the representative embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out above.

What is claimed is:

1. A slot game apparatus for enhancing gaming awards in a slot game, comprising:
a display presenting a plurality of symbols in symbol locations forming a symbol array, and presenting at least one gaming ticket;
a user interface including at least one user input to enable a player to initiate and participate in successive slot game events presented via the symbol array;
a wager input device structured to identify and validate player assets, and to permit the player to play the slot game events when the player assets are provided; and
a processor configured to:
configure a gaming ticket to have a plurality of ticket symbols hidden to the player, and to include at least one winning combination of the ticket symbols among the plurality of ticket symbols;
expose one of the ticket symbols in connection with one of the slot game events;
determine whether a qualifying number of like ones of the ticket symbols have been exposed over a plurality of the slot game events;
if the at least one of the winning combination of the ticket symbols occurs as a result of a qualifying number of like ones of the ticket symbols being exposed, confer a gaming ticket award established for the winning combination of the ticket symbols; and
if the at least one of the winning combination of the ticket symbols does not occur, cause the display to present the gaming ticket in association with another one of the slot game events.

2. The slot game apparatus of claim 1, wherein the slot game events comprise a slot game reel spin.

3. The slot game apparatus of claim 2, wherein the processor is configured to cause the display to present the game play ticket for each slot game reel spin.

4. The slot game apparatus of claim 2, wherein the processor is configured to cause the display to present the game play ticket on random ones of the slot game reel spins.

5. The slot game apparatus of claim 2, wherein the processor is configured to cause the display to present the game play ticket as a result of an occurrence in the symbol array of the slot game event.

6. The slot game apparatus of claim 1, wherein the exposing of one of the ticket symbols, and the determining whether a qualifying number of like ticket symbols have been exposed over a plurality of the slot game events, repeats on subsequent ones of the slot game events until the qualifying number of like ones of the ticket symbols have been exposed.

7. The slot game apparatus of claim 1, wherein the processor is further configured to configure a new one of the gaming tickets in response to the qualifying number of like ones of the ticket symbols having been exposed.

8. The slot game apparatus of claim 1, wherein the processor is configured to cause the display to present the gaming ticket in association with a next consecutive one of the slot game events if the at least one of the winning combination of the ticket symbols does not occur.

9. The slot game apparatus of claim 1, wherein the processor is configured to cause the display to present the gaming ticket in association with a future, nonconsecutive one of the slot game events if the at least one of the winning combination of the ticket symbols does not occur.

10. The slot game apparatus of claim 1, wherein the processor is configured to expose a randomly-selected one of the ticket symbols in connection with one of the slot game events.

11. The slot game apparatus of claim 1, wherein the processor is configured to expose a player-selected one of the ticket symbols in connection with one of the slot game events.

12. The slot game apparatus of claim 1, wherein the processor is configured to expose a plurality of the ticket symbols in connection with one of the slot game events.

13. A gaming apparatus utilizing symbols to identify winning results, comprising:
a symbol selection module configured to select symbols for a slot game event;
a display to present the selected symbols in a symbol array of the slot game event, and to display a state of a multi-symbol gaming ticket;
a ticket configuration module configured to configure the multi-symbol gaming ticket with ticket symbols originally hidden from player perception;
a ticket item selection module coupled to the ticket configuration module and configured to select and reveal one of the ticket symbols;
a ticket analysis module coupled to the ticket item selection module to identify whether a qualifying number of like symbols have been revealed on the multi-symbol gaming ticket over the course of a plurality of the slot game events; and
an award enhancement module to grant a ticket-based award in response to the qualifying number of like symbols having been revealed on the multi-symbol gaming ticket over the course of the plurality of the slot game events.

14. The gaming apparatus of claim 13, wherein the ticket item selection module is configured to select and reveal one of the ticket symbols each time a new one of the slot game events occurs, until the multi-symbol gaming ticket has expired.

15. The gaming apparatus of claim 13, further comprising a slot symbol selection module configured to select the symbols for the slot game event, and wherein the award enhancement module is configured to provide the ticket-based award in the form of a guaranteed gaming result to the slot symbol selection module to cause the symbol selection module to force the guaranteed gaming result to occur via the symbol array of the slot game event.

16. The gaming apparatus of claim 13, further comprising a slot symbol selection module configured to select the symbols for the slot game event, and wherein the award enhancement module provides information to the slot symbol selection module to change the symbols on a subsequent one of the slot game events to increase the chance of winning via the slot game event.

17. The gaming apparatus of claim 13, further comprising a slot symbol selection module configured to select the symbols for the slot game event, and wherein the award enhancement module provides information to the slot symbol selection module to change the symbols on a subsequent one of the slot game events to increase the chance of winning a larger payout via the slot game event.

18. The gaming apparatus of claim 13, further comprising a primary award identification module coupled to the slot symbol selection module to identify winning gaming payouts resulting from the slot game event, and coupled to the award enhancement module to receive the ticket-based award in the form of a payout modifier, wherein the primary award identification module is further configured to increase the winning gaming payouts by the payout modifier.

19. A method for providing an award to a player participating in a gaming activity, comprising:
configuring a game play ticket to have a plurality of ticket symbols hidden to the player, and at least one winning combination of the ticket symbols among the plurality of ticket symbols;
presenting the game play ticket in association with a gaming event of the gaming activity;
exposing one of the ticket symbols;
determining whether a qualifying number of like ones of the ticket symbols have been exposed;
if the at least one of the winning combination of the ticket symbols occurs as a result of a qualifying number of like ones of the ticket symbols being exposed, confer a game play ticket award defined for the winning combination of the ticket symbols; and
if the at least one of the winning combination of the ticket symbols does not occur, present the game play ticket in association with another one of the gaming events.

20. The method of claim 19, wherein the gaming activity comprises a slot game, and the gaming event comprises a randomization of slot game symbols on a slot game grid for win analysis.
